(19) United States
(12) Patent Application Publication
(10) Pub. No.: US 2017/0330472 A1
(43) Pub. Date: Nov. 16, 2017

(54) WIRELESS ON-SITE TEACHING SYSTEM

(71) Applicant: JETION INTERNATIONAL LIMITED, Guangzhou (CN)

(72) Inventor: Huajun Shu, Guangzhou (CN)

(21) Appl. No.: 15/663,977

(22) Filed: Jul. 31, 2017

Related U.S. Application Data
(63) Continuation of application No. PCT/CN2015/087005, filed on Aug. 14, 2015.

(30) Foreign Application Priority Data
Mar. 5, 2015 (CN) 201510098543.6

(51) Int. Cl. G09B 5/12; H04N 5/3745; H04N 5/232; G06T 11/60; G09B 5/10; G09B 5/02; H04N 5/378; H04N 5/243

(52) U.S. Cl. CPC G09B 5/125; H04N 5/378; H04N 5/37455; H04N 5/243; G06T 11/60; G09B 5/10; G09B 5/02; H04N 5/23293

(57) ABSTRACT

Disclosed is a wireless on-site teaching system, comprising a video-capture device and at least one display terminal device. The video-capture device comprises a Complementary Metal-Oxide-Semiconductor (CMOS) sensor, a signal processor, a buffer, and a wireless Access Point (AP) module. The CMOS sensor is configured to convert a collected optical signal to a parallel video digital signal. The signal processor is configured to convert the parallel video digital signal to a serial video digital signal. The buffer is configured to cache the serial video digital signal. The wireless AP module is configured to send the serial video digital signal out wirelessly. The display terminal device comprises a wireless receiving module and a display module. In the present invention, a video-capture device can be simultaneously connected to multiple display terminal devices, and is free of limitation; the display terminal device can directly display video data, improving learning effects.

### TECHNICAL FIELD

The present invention relates to the field of office teaching, and more specifically, to a wireless on-site teaching system.

### BACKGROUND OF THE INVENTION

With the development of science and technology, the traditional teaching environment and methods have been impacted and challenged. Rapid development of information technology has led to profound changes in education, the past teaching environment of projecting the image or video on the curtain through the projector has been outdated, and the effect of teaching is limited.

High-speed photographic apparatus, also known as speed shot instrument, can complete high-speed scanning at one second, and has OCR text recognition function, so that the scanned image can be recognized and transferred into an editable word document. It can also take pictures, videos, copies, network paperless fax, making e-books, cutting edge, righting and other operations. High-speed photographic apparatus is usually used as a teacher preparation or a real-time display the contents of the book on the computer in class.

The existing high-speed photographic apparatus has the following shortcomings:

1. Only a single laptop or desktop computer can be connected via USB cable, whereas tablet, smart phone, or other intelligent terminal devices cannot be connected.

2. Existing cable scanners cannot move freely in a wide range due to the constraints of the cable.

Softwares accompany with the existing high-speed photographic apparatus have the following shortcomings:

1) fail to integrate teaching commonly used function multi-window contrast teaching, lack of interaction.

2) unable to take pictures or video recording when the students watching the big screen of the physical display or other operations.

3) when teachers prepare lessons, there are needs to use other tools to record the screen, there being no integrated screen recording function, having switching program trouble, low efficiency.

4) users have to shoot the photo first, then open the courseware document and then inserted the photo taken into the document, annoying lock operation and lower efficiency.

### SUMMARY OF THE INVENTION

In order to solve the shortcomings of the prior art, the present invention provides a wireless on-site teaching system, so that various kinds of display terminal devices can be connected to a video collection device (wireless scanner), and in the teaching display process, the student can directly display the collected contents of the video-capture device through his own display terminal device.

An embodiment of the present invention provides a wireless on-site teaching system, comprising a video-capture device and at least one display terminal device.

The video-capture device includes a Complementary Metal-Oxide-Semiconductor (CMOS) sensor, a signal processor, a buffer, and a wireless Access Point (AP) module.

The CMOS sensor is configured to convert the acquired optical signal into a parallel video digital signal.

A signal processor is configured to convert a parallel video digital signal into a serial video digital signal.

The buffer is configured to cache the serial video digital signal.

The wireless AP module is configured to transmit the serial video digital signal in the buffer wirelessly.

The display terminal device includes a wireless receiving module and a display module.

The wireless receiving module is configured to receive the serial video digital signal from the wireless AP module.

And the display module is used to display the serial video digital signal received by the wireless receiving module.

Further, the CMOS sensor includes a pixel array scanning circuit, a signal amplification circuit, an automatic gain control circuit, and an analog-to-digital conversion circuit.

The pixel array scanning circuit is configured to scan an array of pixels built in the CMOS sensor and convert the optical signal into an electrical signal.

The signal amplification circuit configured to amplify an electrical signal obtained by the pixel array scanning circuit.

The automatic gain control circuit is configured to automatically adjust the gain of the signal amplification circuit with signal strength.

And the analog-to-digital conversion circuit is configured to convert the electrical signal outputted from the signal amplification circuit into a parallel video digital signal.

Further, the wireless AP module includes a signal encapsulation unit and a signal broadcasting unit.

The signal encapsulation unit is configured to encapsulate Service Set Identifier (SSID) of the video-capture device and the serial video digital signal in the buffer; the signal broadcasting unit is configured to transmit the SSID and the serial video digital signal encapsulated together.

Further, the wireless AP module is model RT5350.

Further, the display terminal device also comprises a controllable module and a storage module; the controllable module comprises a screenshot unit; the screenshot unit is configured to intercept any one of the images displayed by the display module and the intercepted images are stored through the storage module.

Further, the controllable module also comprises a video unit; the video unit is configured to acquire any successive multi-frame images displayed by the display module and the successive multi-frame images are stored through the storage module.

Further, the controllable module also comprises a plurality of window display units; the multi-window display unit is configured to simultaneously open a plurality of display windows; the content of the display module is displayed in one of the display windows opened therein.

Further, the controllable module also comprises an editing unit; the editing unit is configured to draw or input text on any one of the display windows.

The embodiment of the present invention has the following advantageous effects:

The wireless on-site teaching system provided by the embodiment of the invention has the advantages that the video-capture device itself has a wireless AP module which can be connected with a plurality of display terminal devices at the same time, and the position of the video-capture device is not limited and can be moved in a wide range; the display terminal device can directly display the video data, and can screenshot, video or edit annotations, etc. as students required, which is convenient for students to study after class and improve learning results; through multi-window contrast display, the interactivity is increased. At the same time, it is also convenient for teachers to prepare lessons.

### BRIEF DESCRIPTION OF THE DRAWINGS

FIG. 1 is a schematic diagram of a wireless on-site teaching system provided by the present invention;

FIG. 2 is a structural schematic view of the video-capture device 1 of FIG. 1;

FIG. 3 is a structural schematic view of the CMOS sensor 11 in FIG. 2;

FIG. 4 is a structural schematic diagram of the wireless AP module 14 in FIG. 3;

FIG. 5 is a structural schematic view of the display terminal device 2 in FIG. 1;

FIG. 6 is a structural schematic view of the controllable module 23 in FIG. 5.

### DETAILED DESCRIPTION OF THE INVENTION

The technical scheme of the embodiments in the present invention will be described clearly and completely in conjunction with the accompanying drawings, and it is apparent that the described embodiments are merely a part of the embodiments of the invention, not the whole. All other embodiments obtained by those of ordinary skill in the art without creative work based on embodiments of the invention are within the scope of the present invention.

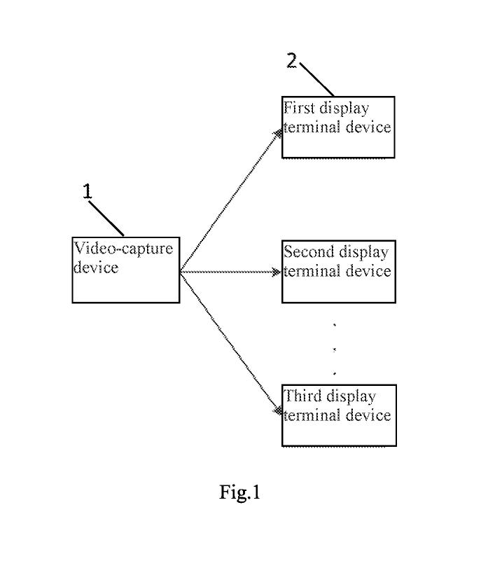

Referring to FIG. 1, a structural schematic view of a wireless on-site teaching system provided by an embodiment of the present invention comprises: a video-capture device 1 and at least one display terminal device 2. In FIG. 1, at least one display terminal device 2 is represented by a first display terminal device, a second display terminal device and a third display terminal device.

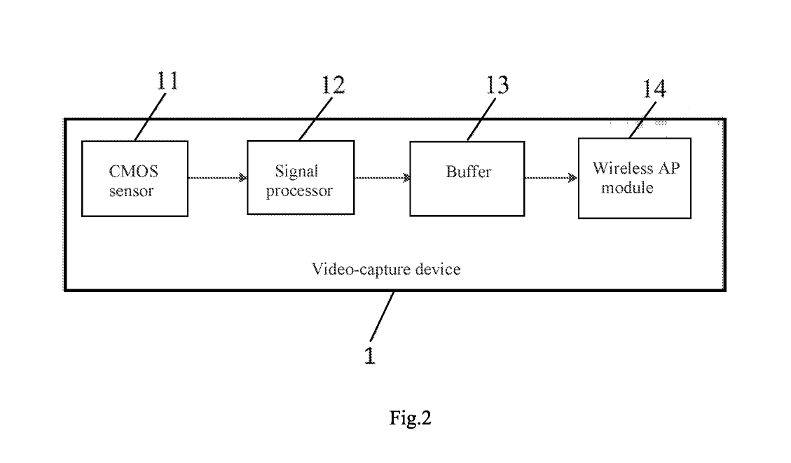

Referring to FIG. 2, a structural schematic view of the video-capture device 1 of FIG. 1, the video-capture device 1 includes a CMOS sensor 11, a signal processor 12, a buffer 13, and a wireless AP module 14.

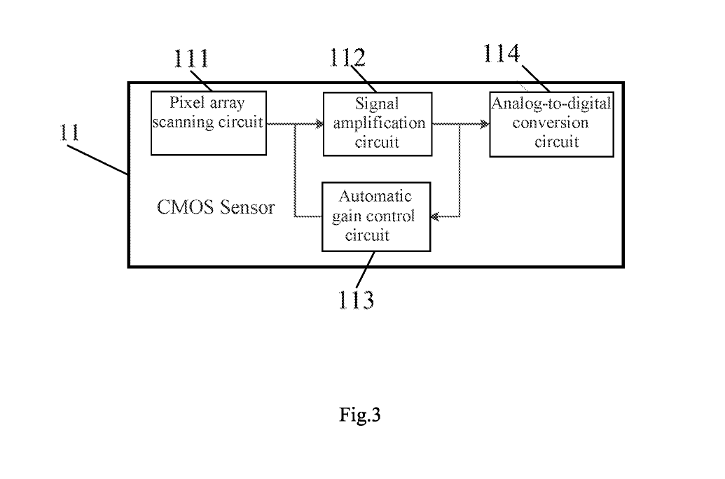

Referring to FIG. 3, a structural schematic view of the CMOS sensor 11 in FIG. 2, the CMOS sensor 11 includes a pixel array scanning circuit 111, a signal amplification circuit 112, an automatic gain control circuit 113, and an analog-to-digital conversion circuit 114.

The pixel array scanning circuit 111 is connected to the input terminal of the signal amplification circuit 112. The pixel array scanning circuit 111 is configured to scan an array of pixels built in the CMOS sensor 11 to obtain an electrical signal of a picture. The pixel array is composed of a plurality of pixel units, and the pixel unit accumulates the corresponding charges in accordance with the intensity of the light beam, so that an electrical signal of a frame can be obtained after the periodic scanning of the pixel array scanning circuit 111.

The output terminal of the signal amplification circuit 112 is connected to the input terminal of the analog-to-digital conversion circuit 114, and the output terminal of the signal amplification circuit 112 is connected to the input terminal of the signal amplification circuit 112 through the automatic gain control circuit 113. The signal amplification circuit 112 is configured to amplify the electric signal obtained by the pixel array scanning circuit 111.

An automatic gain control circuit 113 is configured to automatically adjust the gain of the signal amplification circuit 112 with the signal strength to ensure that the output of the signal amplification circuit 112 is not greatly changed and the conversion accuracy of the analog-to-digital conversion circuit 114 is improved.

The output terminal of the analog-to-digital conversion circuit 114 is connected to the signal processor 12 through a parallel bus. The analog-to-digital conversion circuit 114 is configured to convert the electrical signal output from the signal amplification circuit 112 into a parallel video digital signal.

The signal processor 12 is connected to the buffer 13. The signal processor 12 is for converting the parallel video digital signal output from the analog-to-digital conversion circuit 14 into a serial video digital signal. The buffer 13 is used to cache serial video digital signals.

The buffer 13 is connected to the wireless AP module 14 via a serial bus. The wireless AP module 14 is configured to process the serial video digital signal in the buffer 13 and broadcast for use by other display terminal devices 2.

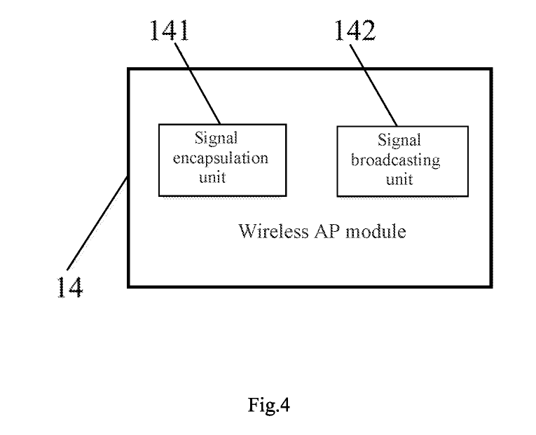

In particular, the wireless AP module 14 includes a signal encapsulation unit 141 and a signal broadcasting unit 142. As is shown in FIG. 4, which is a structural schematic view of the wireless AP module 14 in FIG. 3. The signal encapsulation unit 141 is connected to the signal broadcasting unit 142. The signal encapsulation unit 141 encapsulates the device SSID and the serial video digital signal together and transmits it through the signal broadcasting unit 142.

In the present embodiment, the wireless AP module 14 is model RT5350.

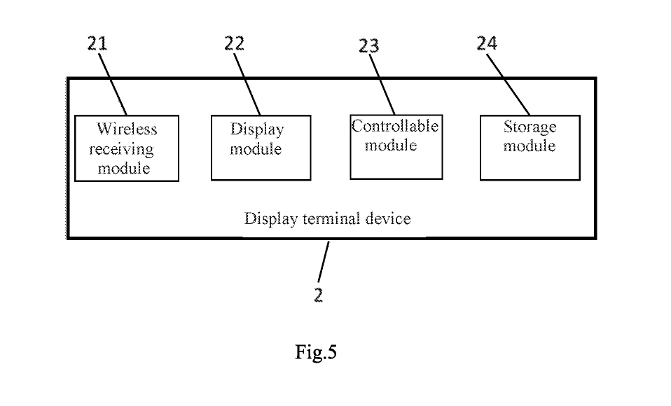

Referring to FIG. 5, which is a structural schematic view of the display terminal device 2 in FIG. 1. The display terminal device 2 can be a wireless terminal device such as a mobile phone, a tablet computer, or a portable computer.

The display terminal device 2 includes a wireless receiving module 21, a display module 22, a controllable module 23, and a storage module 24.

The wireless receiving module 21 is configured to receive the serial video digital signal from the wireless AP module 14.

The display module 22 is configured to display the serial video digital signal received by the wireless receiving module 21.

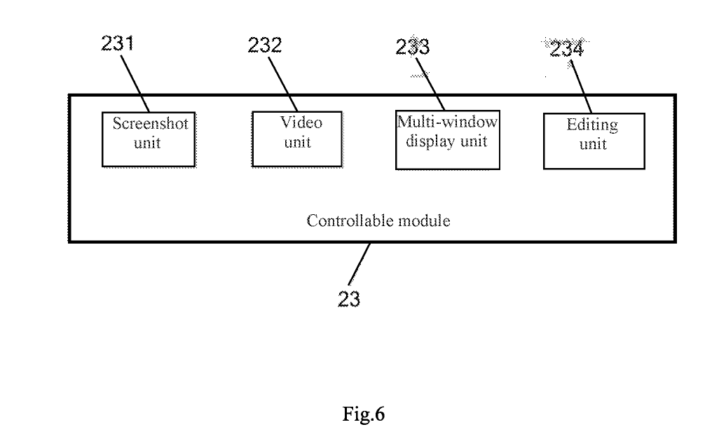

Referring to FIG. 6, which is a structural schematic view of the controllable module 23 in FIG. 5.

The controllable module 23 includes a screenshot unit 231, a video unit 232, a multi-window display unit 233, and an editing unit 234.

The screenshot unit 231 is configured to intercept any one of the images displayed by the display module 22 and the intercepted images are stored through the storage module 24. Through the screenshot unit 231, the student can store the image of a certain screen at any time so that it can be used for revision after class.

The video unit 232 is configured to acquire any successive multi-frame images displayed by the display module 22 and the successive multi-frame images are stored through the storage module 24. Through the video unit 232, the student can store a certain video at any time to be used for revision after class.

The multi-window display unit 233 is configured to simultaneously open a plurality of display windows; the content of the display module 22 is displayed in one of the display windows opened therein. Through the multi-window display unit 233, students can choose to display existing picture files in different windows, instantly take pictures, and live video display for multi-window contrast teaching.

The editing unit 234 is configured to draw or input text on any one of the display windows, which is convenient for students or teachers to do annotations at any time.

The wireless on-site teaching system provided by the embodiment of the invention works as follows: the teacher collects the video data in real time through the video-capture device 1 and sends it through the wireless AP module 14. After the student opens the display terminal device, the SSID of the video-capture device 1 is searched and the video-capture device 1 is wirelessly connected. After connection, the real-time video data is received and displayed. Students can screenshot, video, multi-window contrast display or edit annotations during the viewing process, greatly increasing the interactivity and improving the learning effects comprehensively.

The wireless on-site teaching system provided by the embodiment of the invention has the following advantageous effects: the video collection device itself has a wireless AP module which can be connected with a plurality of display terminal devices at the same time, and the position of the video-capture device 1 is not limited and can be moved in a wide range; the display terminal device can directly display the video data, and can screenshot, video or edit annotations, etc. as students required, which is convenient for students to study after class, and improve learning results; through multi-window contrast display, the interactivity is increased. At the same time, it is also convenient for teachers to prepare lessons.

The above disclosure is the preferred embodiment of the invention, it should be pointed out that any improvements and polishing without departing from the principle of the invention made by those common skilled in the art are also regarded as the scope of the invention.

What is claimed is:

1. A wireless on-site teaching system, characterized by comprising: a video-capture device and at least one display terminal device;
the video-capture device includes a Complementary Metal-Oxide-Semiconductor (CMOS) sensor, a signal processor, a buffer, and a wireless Access Point (AP) module;
the CMOS sensor is configured to convert an acquired optical signal into a parallel video digital signal;
the signal processor is configured to convert a parallel video digital signal into a serial video digital signal;
the buffer is configured to cache the serial video digital signal;
the wireless AP module is configured to transmit the serial video digital signal in the buffer wirelessly;
the display terminal device includes a wireless receiving module and a display module;
the wireless receiving module is configured to receive the serial video digital signal from the wireless AP module;
the display module is configured to display the serial video digital signal received by the wireless receiving module;
the display terminal device further comprises a controllable module and a storage module;
the controllable module comprises a screenshot unit;
the screenshot unit is configured to intercept any one of images displayed by the display module and the intercepted images are stored through the storage module;
the video unit is configured to acquire any successive multi-frame images displayed by the display module and the successive multi-frame are stored through the storage module;
the multi-window display unit is configured to simultaneously open a plurality of display windows; and the content of the display module is displayed in one of the display windows opened therein.

2. The wireless on-site teaching system of claim 1, wherein the CMOS sensor includes a pixel array scanning circuit, a signal amplification circuit, an automatic gain control circuit, and an analog-to-digital conversion circuit;
the pixel array scanning circuit is configured to scan an array of pixels built in the CMOS sensor and convert the optical signal into an electrical signal;
the signal amplification circuit is configured to amplify an electrical signal obtained by the pixel array scanning circuit;
the automatic gain control circuit is configured to automatically adjust the gain of the signal amplification circuit with signal strength; and
the analog-to-digital conversion circuit is configured to convert the electrical signal outputted from the signal amplification circuit into a parallel video digital signal.

3. The wireless on-site teaching system of claim 1, wherein the wireless AP module comprises a signal encapsulation unit and a signal broadcasting unit;
the signal encapsulation unit is configured to encapsulate Service Set Identifier (SSID) of the video-capture device and the serial video digital signal in the buffer; and the signal broadcasting unit is configured to transmit the SSID and the serial video digital signal encapsulated together.

4. The wireless on-site teaching system of claim 3, wherein the wireless AP module is model RT5350.

5. The wireless on-site teaching system of claim 1, wherein the controllable module further comprises an editing unit; and the editing unit is configured to draw or input text on any one of display windows.
